(19) United States
(12) Patent Application Publication
(10) Pub. No.: US 2011/0027591 A1
(43) Pub. Date: Feb. 3, 2011

(54) Aqueous two-component or multicomponent aqueous epoxy resin primer composition

(75) Inventors: Andreas Braun, Wolfhalden (CH); Wolf-Rüdiger Huck, Zurich (CH)

Correspondence Address: OLIFF & BERRIDGE, PLC, P.O. BOX 320850, ALEXANDRIA, VA, 22320-4850, US

(73) Assignee: SIKA TECHNOLOGY AG, BAAR (CH)

(21) Appl. No.: 12/311,422

(22) PCT Filed: Sep. 28, 2007
(86) PCT No.: PCT/EP2007/060282

§ 371 Date: Apr. 16, 2010

(30) Foreign Application Priority Data
Sep. 29, 2006 (EP) 06121541.4

(51) Int. Cl. C09D 163/00; C09J 5/04; B32B 7/12; B32B 27/38

(52) U.S. Cl. 428/414; 523/402; 156/314; 156/315; 156/310

(57) ABSTRACT

The invention relates to two-component or multicomponent aqueous epoxy resin primer compositions comprising a first component, a second component, and an optional other component. The first component contains at least water and an epoxy resin while the second component contains at least one polyamine. The composition also comprises carbon black and/or epoxy silane and/or epoxy siloxane and/or an amino silane and/or an amino siloxane and/or mercaptosilane. The aqueous epoxy resin primer compositions improve adhesion of moisture-curing polyurethane adhesives or sealants on various bases.

### FIELD OF THE INVENTION

The present invention relates to the field of two-component or multicomponent aqueous epoxy resin primer compositions.

### DESCRIPTION OF THE PRIOR ART

Primers have already long been used to enhance the adhesion of adhesives and sealants to diverse substrates. Epoxy resin compositions are known to have a relatively good spectrum of adhesion to a very wide variety of substrates. For a fairly long time already, therefore, epoxy resin compositions have been known as primers. These epoxy resin primer compositions are based on epoxy resins, are one-component compositions, and typically include solvent. Customarily these primers are physically curing, forming a polymer film through the evaporation of the solvent.

Particularly with polyurethane adhesives, however, these primers that cure purely by physical means have a number of disadvantages.

Two-component epoxy resin compositions with a resin component and an amine component have already been used for a long time as adhesives and coatings. Owing to the problem of the use of solvent, particularly with regard to regulations concerning VOC (volatile organic compounds), the market, for reasons of occupational hygiene and safety, is increasingly calling for solvent-free primers. Primer systems of this kind, however, are difficult to formulate.

Two-component aqueous compositions composed of an epoxy resin component and a polyamine component are already being used as coatings or as part of epoxy resin cement mortar compositions, as disclosed in EP-A-0 567 831, for example. They are also used as primers for the bonding or coating of concrete with epoxy resin adhesives or epoxy resin coatings.

To date, however, two-component aqueous primer compositions of this kind have not been used as primers for moisture-curing adhesives, since in many cases they lack adequate adhesion, particularly after storage under hot and humid conditions.

### SUMMARY OF THE INVENTION

It is an object of the present invention, therefore, to provide aqueous epoxy resin primer compositions which lead to improved adhesion of moisture-curing polyurethane adhesives and which more particularly improve the adhesion after storage under hot and humid conditions.

Surprisingly it has emerged that this object can be achieved by a two-component or multicomponent aqueous primer composition in accordance with claim 1.

More particularly it has emerged that the adhesion is greatly improved through the addition of carbon black and/or epoxysilane and/or epoxysiloxane and/or aminosilane and/or aminosiloxane and/or mercaptosilane.

It has additionally emerged that, in particular, primer compositions with solid epoxy resin lead to a sharp improvement.

Further aspects of the present invention include the use of such two-component or multicomponent aqueous primer compositions as primers for polyurethane adhesives and/or polyurethane sealants, and also a method of adhesive bonding or of sealing, and the resultant articles.

Preferred embodiments are subject matter of the dependent claims.

### DESCRIPTION OF THE PREFERRED EMBODIMENTS

The present invention relates to two-component or multicomponent aqueous primer compositions which are composed of a first component K1, a second component K2, and, if desired, at least one further component.

Component K1 comprises at least water and an epoxy resin A.

Component K2 comprises at least one polyamine B.

The two-component or multicomponent aqueous primer composition further comprises carbon black and/or at least one epoxysilane ES and/or at least one epoxysiloxane ESx and/or at least one aminosilane AS and/or at least one aminosiloxane ASx and/or at least one mercaptosilane MS with the proviso that, where epoxysilane ES and/or epoxysiloxane ESx are present, they/it are/is not present in the same component as the optionally present aminosilane AS and/or aminosiloxane ASx.

The epoxy resin A preferably has more than one epoxide group per molecule and is preferably a liquid epoxy resin or a solid epoxy resin. The term “solid epoxy resin” is very well known to the epoxide person skilled in the art, and is used in contrast to “liquid epoxy resins”. The glass transition temperature of solid resins is above room temperature, i.e., they can be comminuted to free-flowing powders at room temperature.

Preferred liquid epoxy resins have the formula (IX)

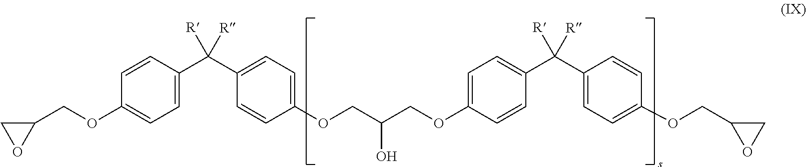

In this formula the substituents R′ and R″ independently of one another stand either for H or CH₃. Moreover, the index s stands for a value from 0 to 1. Preferably s stands for a value of less than 0.2.

These are, therefore, preferably diglycidyl ethers of bisphenol A (DGEBA), of bisphenol F, and of bisphenol A/F (the designation “A/F” here refers to a mixture of acetone with formaldehyde which is used as a reactant in its preparation). Liquid resins of this kind are available, for example, as Araldite® GY 250, Araldite® PY 304, Araldite® GY 282 (Huntsman) or D.E.R.™ 331 or D.E.R.™ 330 (Dow) or Epikote 828 (Resolution).

Preferred solid epoxy resins have the formula (X)

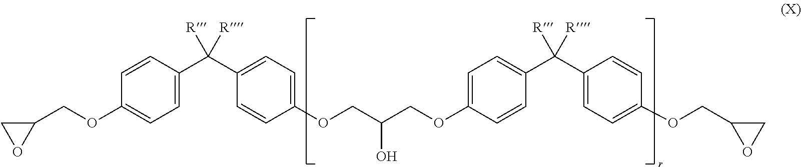

In this formula the substituents R′″ and R″″ independently of one another stand either for H or CH₃. Moreover, the index r stands for a value >1.5, more particularly of 2 to 12.

Solid epoxy resins of this kind are available commercially as pure solids or as aqueous dispersions, from Dow or Huntsman or Resolution, for example.

More preferably the epoxy resin A is a solid epoxy resin A. Solid epoxy resins exhibit the great advantage over liquid epoxy resins that a two-component or multicomponent aqueous primer composition formulated therewith is tack-free significantly more quickly, which represents a substantial advantage, of course, for its use as a primer, since it allows the waiting time between the application of the primer and the application of an adhesive or sealant to the primer to be shortened greatly.

Further suitable epoxy resins A are, firstly, epoxy resins with N-glycidyl groups, such as, for example, those of the following three formulae:

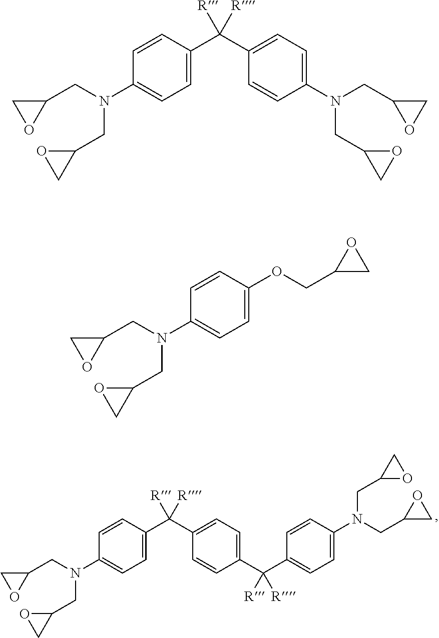

particularly in the forms in which they are commercialized as Araldite® MY 721, MY 722, MY 720, MY 9512 or MY 510 by Huntsman or as Epon HPT 1072 by Shell.

Secondly, further suitable epoxy resins A are those which are based on aliphatic glycidyl ethers, such as, for example, the epoxy resins of the following two formulae:

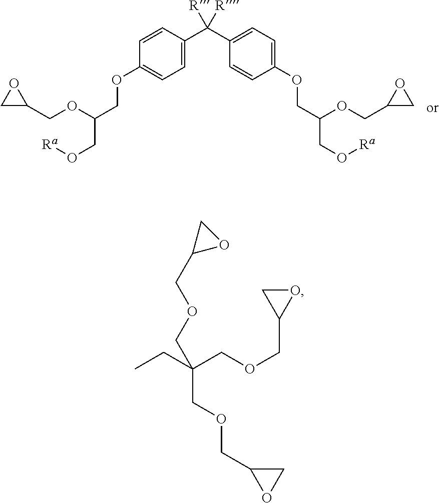

where Ra stands for a linear or branched alkyl radical, more particularly having 4 to 8 C atoms.

Moreover, further suitable epoxy resins A are those which have the following formula

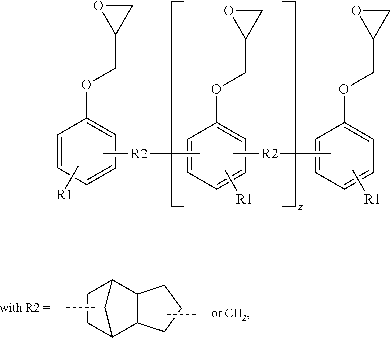

R1=H or methyl, and z=0 to 7.

More particularly these are phenol or cresol novolaks (R2=CH₂).

Epoxy resins of this kind are available commercially from Huntsman under the tradename EPN or ECN and also Tactix®556; various EPN and ECN grades are also offered by Huntsman, for example, as a dispersion in water.

Additionally, further suitable epoxy resins A are glycidyl esters, of the kind commercialized, for example, as Araldite® PT 910 or PY 184 by Huntsman.

The epoxy resins A that have proven to be the most suitable are solid bisphenol A diglycidyl ether resins, more particularly those having an epoxide equivalent weight (EEW) of between 700 and 750 g/eq.

The fraction of the epoxy resins A as a proportion of the weight of the first component K1 is preferably 800 to 30% by weight, more particularly 65% to 50% by weight.

The first component K1 further comprises water. The water is mixed in a known manner with the epoxy resin A and, where appropriate, further constituents of the first component. Depending on the epoxy resin used, an emulsion or a dispersion is formed. A dispersion is preferred. It has emerged that epoxy resin dispersions of this kind in particular are preferred in which the epoxy resin A is a solid epoxy resin A and has a volume-average diameter of less than 1 μm, more particularly of between 0.25 μm and 0.75 μm, preferably of between 0.4 and 0.6 μm.

It is clear to a person skilled in the art that commercially available epoxy resin emulsions or epoxy resin dispersions as well are used as component K1 or part thereof. Preferred more particularly are epoxy resin dispersions of the kind sold by Cognis as Waterpoxy® 1422 or by Air Products as Ancarez 550™ AR 550 Waterborne Epoxy Resin.

If desired it is possible subsequently to mix further constituents of component K1 into this epoxy resin emulsion or dispersion.

It may well where appropriate be necessary or of advantage for the first component K1 to contain further constituents, of the kind already known to a person skilled in the art for the preparation of aqueous epoxy resin emulsions or dispersions, such as, for example, solvents, emulsifiers, co-emulsifiers, defoamers, biocides, pigments, fillers, reactive diluents or catalysts.

The fraction of water as a proportion of the weight of the first component K1 is preferably 20% to 70% by weight, more particularly 35% to 50% by weight.

Component K1 has in particular a viscosity at 25° C. by the Brookfield method of between 50 mPas and 8000 mPas, preferably between 90 mPas and 6000 mPas, in particular between 90 mPas and 1000 mPas.

The second component K2 comprises at least one polyamine B. Polyamine always has a plurality of amino groups, i.e., two or more than two amino groups. The polyamine B is more particularly a reaction product, more particularly an amidoamine, a polyamide or an epoxy resin/polyamine adduct.

In a first embodiment the polyamine B is an amidoamine. These are, for example, condensation products of carboxylic acids with polyamines. One possibility for such is a monoamide of a fatty acid and a polyalkylenamine.

In a second embodiment the polyamine B is a polyamide.

Such polyamides contain two or more amide groups and two or more amino groups at the same time. One possibility for such are condensation products of polycarboxylic acids and polyamines.

In a third embodiment the polyamine B is an epoxy resin/polyamine adduct. Epoxy resin/polyamine adducts of this kind can be obtained, for example, from a multiplicity of possible polyamines and epoxy resins that are known to a person skilled in the art, more particularly bisphenol A diglycidyl ethers. Preferred polyamines for this purpose are ethylenediamine, polyethylenediamines or polyoxyalkylenediamines or -triamines, more particularly of the kind sold under the name Jeffamine® by Huntsman. In particular the reaction product is that of a diglycidyl ether of bisphenol A and/or bisphenol F with a polyoxyalkylene-diamine or polyoxyalkylenetriamine, more particularly with a polyoxyalkylenediamine. One particularly suitable epoxy resin/polyamine adduct is that which in EP-A-0 567 831 is designated as bis(diamine)-diepoxide adduct.

The fraction of polyamime B as a proportion of the weight of the second component K2 is typically 5% to 90%, preferably 5% to 70%, more particularly 10% to 60% by weight.

It is an advantage, moreover, if the second component K2 comprises water, typically in an amount of 20% to 95%, preferably of 20% to 70%, more particularly of 35% to 50% by weight.

It is clear to a person skilled in the art that commercially available aqueous polyamines can also be used as component K2 or part thereof. More particular preference is given to aqueous polyamines of the kind offered for sale, for example, by Cognis as Waterpoxy® 751 or by Air Products in the line bearing the tradename Anquamine®, more particularly Anquamine® 419 or Anquamine® 401.

It may if appropriate be necessary or of advantage for the first component K2 to contain further constituents of the kind already known to a person skilled in the art for the preparation of aqueous polyamine compositions, such as, for example, solvents, emulsifiers, co-emulsifiers, defoamers, biocides, pigments, fillers or catalysts.

Particularly emulsifiers and co-emulsifiers are used with advantage. In certain embodiments, more particularly in those in which use is made as polyamine B of an epoxy resin/polyamine adduct which in EP-A-0 567 831 is designated as bis(diamine)-diepoxide adduct, it is of advantage for the second component K2 to comprise an emulsifier having a polyoxy-alkylenediamine structure and/or a coemulsifier having a poly(alkylene)polyamine structure.

In one preferred embodiment the first component K1 and/or second component K2 comprises at least one emulsifier and/or surfactant.

In a further preferred embodiment the epoxy resin A is present as a dispersion in water in the first component K1 and the polyamine B is present as an emulsion or dispersion in water in the second component K2.

The aqueous polymer composition further comprises carbon black and/or at least one epoxysilane ES and/or at least one epoxysiloxane ESx and/or at least one aminosilane AS and/or at least one aminosiloxane ASx and/or at least one mercaptosilane MS.

Preferred carbon black is, in particular, carbon black that is manufactured industrially.

The term “silane” refers in the present document in the narrower sense to organosilicon compounds in which on the one hand there is at least one, typically two or three, hydrolysable groups, more particularly alkoxy or acyloxy groups, attached to the silicon atom (via an Si—O bond), and which, on the other hand, contain at least one organic radical attached directly to the silicon atom (via an Si—C bond). The silanes which contain hydrolysable groups have the facility to hydrolyze on contact with moisture. This forms organosilanols, i.e., silico-organic compounds containing one or more silanol groups (Si—OH groups). Since it is clear to a person skilled in the art that customarily in silanes there are always—to a greater or lesser extent—hydrolyzed or part-hydrolyzed silanes present as well, i.e., silanols, it is the case, accordingly, that silanols are also considered to be “silanes” in the wider sense in this document. Accordingly, “silanes” in the wider sense in this document identify organosilicon compounds in which on the one hand there is at least one, customarily two or three, hydrolysable groups, more particularly alkoxy or acyloxy groups, or OH groups attached to the silicon atom (via an Si—O bond) and which, on the other hand, contain at least one organic radical attached directly to the silicon atom (via an Si—C bond).

As a result of subsequent condensation reactions, siloxanes are formed from the silanes, these siloxanes being silico-organic compounds containing one or more siloxane groups (Si—O—Si groups), and also at least two organic radicals attached directly to silicon via Si—C bonds.

The epoxy group has an oxirane structural element, i.e.,

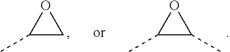

“Aminosilanes”, “mercaptosilanes”, and “epoxysilanes” are silanes whose organic radical contains at least one amino group, mercapto group or epoxy group, respectively. “Aminosiloxanes” and “epoxysiloxanes” are siloxanes whose organic radical contains at least one amino group or at least one epoxy group, respectively.

Amino groups in this document are considered to be primary, secondary, and tertiary amino groups.

The epoxysilane ES carries an epoxy group. 2-(3,4-Epoxycyclohexyl)ethyltrimethoxysilane and 2-(3,4-epoxycyclohexyl)ethyltriethoxysilane are examples of epoxysilanes.

Further examples of epoxysilanes ES are those silanes which carry a glycidyloxy group.

Preferably the epoxysilane ES has the formula (I).

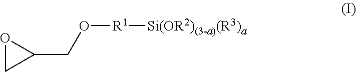

In this formula R¹ is a linear or branched alkylene group having 1 to 6 C atoms, more particularly propylene.

Furthermore, R² is H or an alkyl group having 1 to 4 C atoms, or an acyl group, and R³ is H or an alkyl group having 1 to 10 C atoms. Finally a is 0, 1 or 2.

If R² is an acyl group, the acetyl group is preferred. R² is preferably methyl or ethyl, most preferably methyl.

Preferably a is 0

If a is 1 or 2, methyl is preferred for R³.

The most preferred epoxysilanes ES are 3-glycidyloxy-propyltriethoxysilane and 3-glycidyloxypropyl-trimethoxysilane, more particularly 3-glycidyloxy-propyltrimethoxysilane.

The aminosilane AS preferably contains at least one primary and/or secondary amino group. Preferably the aminosilane contains at least one primary amino group. With particular preference the aminosilane AS is an aminosilane of the formula (II), (III) or (IV):

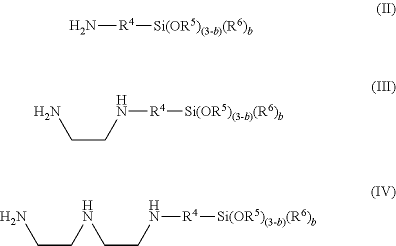

In this formula R⁴ is a linear or branched alkylene group having 1 to 6 C atoms, more particularly propylene.

Furthermore, R⁵ is H or an alkyl group having 1 to 4 C atoms, or an acyl group, and R⁶ is H or an alkyl group having 1 to 10 C atoms. Finally b is 0, 1 or 2.

If R⁵ is an acyl group, the acetyl group is preferred. R⁵ is preferably methyl or ethyl, most preferably methyl.

### Preferably b is 0

If b is 1 or 2, methyl is preferred for R⁶.

Examples of aminosilanes AS of this kind are 3-aminopropyltrimethoxysilane, 3-aminopropyldimethoxy-methylsilane, 3-amino-2-methylpropyltrimethoxysilane, 4-aminobutyltrimethoxysilane, 4-aminobutyldimethoxy-methylsilane, 4-amino-3-methylbutyltrimethoxysilane, 4-amino-3,3-dimethylbutyltrimethoxysilane, 4-amino-3,3-dimethylbutyldimethoxymethylsilane, 2-aminoethyl-trimethoxysilane, 2-aminoethyldimethoxymethylsilane, aminomethyltrimethoxysilane, aminomethyldimethoxy-methylsilane, aminomethylmethoxydimethylsilane, N-(2-aminoethyl)-3-aminopropyltrimethoxysilane, 3-[2-(2-aminoethylamino)ethylamino]propyltrimethoxysilane, and also their analogs with ethoxy or isopropoxy groups instead of the methoxy groups on the silicon.

Preferred aminosilanes AS are 3-aminopropyltrimethoxy-silane, N-(2-aminoethyl)-3-aminopropyltrimethoxy-silane, and 3-[2-(2-aminoethylamino)ethylamino]propyl-trimethoxysilane.

Most preferred as aminosilanes AS is N-(2-aminoethyl)-3-aminopropyltrimethoxysilane.

In one embodiment the aminosilane is the reaction product of one of the aminosilanes of formula (II), (III) or (IV) and of at least one epoxysilane ES, more particularly an epoxysilane of the formula (I). Reaction products of this kind have amino alcohol structure of the formula (V).

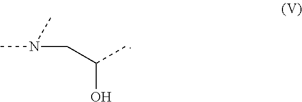

If the aminosilane is a primary aminosilane, the structural element of the formula (VI) sometimes comes about as well.

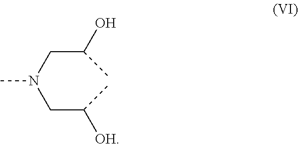

These structural elements of the formulae (V) and (VI) may also be present simultaneously.

An example of such an aminosilane AS is that of the formula (VII), which is a possible reaction product of the aminosilane of the formula (II) and an epoxysilane of the formula (I).

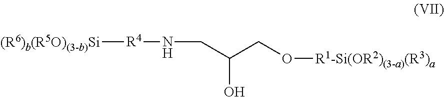

The mercaptosilane MS contains at least one mercapto group. Preferably the mercaptosilanes contain 3-mercaptopropyl as an organic radical of the silane. Particularly preferred mercaptosilanes MS are 3-mercaptopropyltrimethoxysilane and 3-mercaptopropyl-triethoxysilane. Most preferred as mercaptosilane MS is 3-mercaptopropyltrimethoxysilane.

Aminosiloxanes ASx can be prepared in particular from the condensation of an aminosilane AS with a further silane, with formation of at least one siloxane bond. The further silane may also be an aminosilane AS. More particularly the aminosiloxanes ASx are amino-bearing silsesquioxanes. Silsesquioxanes of this kind more particularly contain amino-bearing organic radicals of the formula (IXa), (IXb) or (IXc).

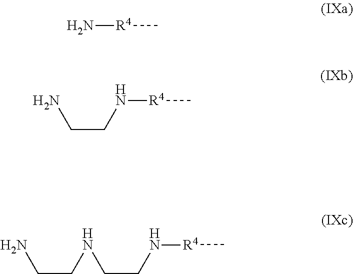

Particularly preferred aminosiloxanes, especially amino-bearing silsesquioxanes, are those which as well as the amino group or the n amino groups also contain phenyl or alkyl groups having 1 to 10 C atoms, preferably methyl, which are attached to silicon directly via an Si—C bond.

Further examples of suitable aminosiloxanes ASx are those of the kind commercialized by Degussa under the tradename Dynasylan® HYDROSIL, especially HYDROSIL 1151, HYDROSIL 2775, HYDROSIL 2776, HYDROSIL 2809 OR HYDROSIL 2929.

Epoxysiloxanes ESx can be prepared in particular from the condensation of an epoxysilane ES with a further silane, with formation of at least one siloxane bond. The further silane may also be an epoxysilane ES.

In particular the epoxysiloxanes ESx are epoxy-bearing silsesquioxanes. Silsesquioxanes of this kind more particularly contain epoxy-bearing organic radicals of the formula (IXa′)

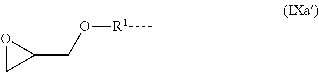

Particularly preferred epoxysiloxanes, especially epoxy-bearing silsesquioxanes, are those which in addition to the epoxy group or epoxy groups contain phenyl groups or alkyl groups having 1 to 10 C atoms, preferably methyl, which are attached to the silicon directly via an Si—C bond.

One example of a suitable epoxysiloxane ESx is Dynasylan® HYDROSIL 2926, as commercialized by Degussa.

Carbon black may be part of component K1 or K2 or may be a further component or part of a further component. It is preferred for carbon black not to be part of the first component K1. This is because it has emerged that the stability of the epoxy resin dispersion or emulsion is negatively influenced if carbon black is part of the first component K1. Preferably carbon black is part of the second component K2.

The epoxysilane ES and/or epoxysiloxane ESx are/is advantageously part of the first component K1 or of a further component. It must be ensured, however, that this further component contains no aminosilane AS and/or aminosiloxane ASx and/or mercaptosilane MS, since otherwise a reaction would take place.

The aminosilane AS may be part of component K1 or K2 or may be a further component or part of a further component. For reasons of stability it is advantageous if the aminosilane is not part of the first component K1. Preferably the aminosilane AS is part of the second component K2.

Aminosiloxane ASx may be part of component K1 or K2 or may be a further component or part of a further component. For reasons of stability it is advantageous if the aminosiloxane is not part of the first component K1. Preferably the aminosiloxane ASx is part of the second component K2.

Mercaptosilane MS may be part of component K1 or K2 or may be a further component or part of a further component. Preferably the mercaptosilane MS is part of the second component K2.

It may be of advantage if a mixture of aminosilane AS and/or aminosiloxane ASx and/or mercaptosilane MS is used as a further component or as part of a further component.

It may, where appropriate, be necessary or of advantage for the further components to contain further constituents, such as, for example, water, solvents, emulsifiers, co-emulsifiers, defoamers, biocides, pigments, fillers or catalysts.

In one embodiment the two-component or multicomponent aqueous primer composition contains three components and it is the third component K3 which comprises carbon black and/or epoxysilane ES and/or epoxysiloxane ESx and/or aminosilane AS and/or aminosiloxane ASx and/or mercaptosilane MS.

In another embodiment the two-component or multicomponent aqueous primer composition contains two components, in which the aminosilane AS and/or aminosiloxane ASx and/or mercaptosilane MS are part of the second component K2. Any epoxysilane ES and/or epoxysiloxane ESx present are/is then part of the first component K1.

The fraction of the carbon black as a proportion of the weight of the two-component or multicomponent aqueous primer composition is advantageously 0% to 20%, preferably 0% to 10%, more particularly 3% to 10% by weight.

The fraction of the epoxysilane ES as a proportion of the weight of the two-component or multicomponent aqueous primer composition is advantageously 0% to 5%, preferably 0% to 2%, more particularly 0.5% to 2% by weight.

The fraction of the epoxysiloxane ESx as a proportion of the weight of the two-component or multicomponent aqueous primer composition is advantageously 0% to 5%, preferably 0% to 2%, more particularly 0.05% to 2% by weight.

The fraction of the aminosilane AS as a proportion of the weight of the two-component or multicomponent aqueous primer composition is advantageously 0% to 5%, preferably 0% to 2%, more particularly 0.5% to 2% by weight.

The fraction of the aminosiloxane ASx as a proportion of the weight of the two-component or multicomponent aqueous primer composition is advantageously 0% to 5%, preferably 0% to 2%, more particularly 0.05% to 2% by weight.

The fraction of the mercaptosilane MS as a proportion of the weight of the two-component or multicomponent aqueous primer composition is advantageously 0% to 5%, preferably 0% to 2%, more particularly 0.5% to 2% by weight.

Advantageously the fraction of the sum by weight of epoxysilane ES and epoxysiloxane ESx and aminosilane AS and aminosiloxane ASx and mercaptosilane MS as a proportion of the weight of the two-component or multicomponent aqueous primer composition is 0% to 10%, preferably 0% to 5%, more particularly 0.5% to 3% by weight.

It is advantageous if the two-component or multicomponent aqueous primer composition comprises—apart from the optionally present epoxysilane ES and/or epoxysiloxane ESx and/or aminosilane AS and/or aminosiloxane ASx and/or mercaptosilane MS, and also the alcohols formed in the hydrolysis—no organic compounds which are defined as VOC (volatile organic compounds)
either according to EU Directive 2004/42/EC, having a boiling point of not more than 250° C. under a standard pressure of 101.3 kPa;
or according to the Swiss ordinance concerning the steering tax on volatile organic compounds, having a vapor pressure of at least 0.1 mbar at 20° C. or a boiling point of not more than 240° C. at 1013.25 mbar.

Following their preparation, the individual components are advantageously packaged into impervious packs. Separately from one another, the two or more components are stable on storage. In the course of storage it ought to be ensured that the temperature as far as possible does not drop below 5° C., more particularly not below 0° C. At these temperatures the stability of the emulsion and/or of the dispersion is often no longer ensured. The temperature ought likewise not to climb above 60° C.

The two-component or multicomponent aqueous primer composition can be used as a primer, more particularly for polyurethane adhesives and/or polyurethane sealants. The aqueous adhesion promoter composition described is suitable more particularly as a primer, preferably as a primer for adhesives and sealants. Using a primer of this kind enhances the adhesion.

A method of adhesive bonding or sealing of this kind comprises the following steps:
i) mixing the two or more components of a two-component or multicomponent aqueous primer composition as described above;
ii) applying the mixed primer composition to a substrate S1 to be bonded or sealed;
iii) flashing off the primer composition;
iv) applying an adhesive or sealant to the flashed-off composition which is on the substrate S1;
v) contacting the adhesive or sealant with a second substrate S2;
or
i′) mixing the two or more components of a two-component or multicomponent aqueous primer composition as described above;
ii′) applying the mixed primer composition to a substrate S1 to be bonded or sealed;
iii′) applying an adhesive or sealant to the surface of a second substrate S2;
iv′) contacting the adhesive or sealant with the flashed-off composition which is on the substrate S1;
or
i″) mixing the two or more components of a two-component or multicomponent aqueous primer composition as described above;
ii″) applying the mixed primer composition to a substrate S1 to be bonded or sealed;
iii″) flashing off the primer composition;
iv″) applying an adhesive or sealant between the surfaces of the substrates S1 and S2; the second substrate S2 being composed of the same or different material as the substrate S1.

The mixing of the two or more components may take place in a diversity of ways.

Flashing off may take place, where appropriate, at elevated temperature and/or, in certain circumstances, with blowing with a gas, which may lead to a—shortening of the flash-off time.

Customarily step v), iv′) or iv″) is followed by a step (vi) of curing the adhesive or sealant.

The mixed two-component or multicomponent aqueous primer composition may be applied by means of cloth, felt, roller, spraying, sponge, brush, dipcoating or the like and may take place both manually and by means of a robot.

Adhesives and sealants are very similar. Both require good adhesion to the substrate in order best to fulfil their function. In the case of the adhesives, the adhesion requirements, and the requirements concerning the forces which must be transmitted between substrate and adhesive, are even higher, however, than for the sealants. Therefore adhesives are preferred in particular.

As adhesive it is possible in principle to use any adhesive. The most-preferred adhesive is a moisture-curing adhesive, the curing of the adhesive taking place by means of curing with moisture, especially atmospheric moisture. On the one hand these are adhesives based on polymers with silane group termination, of the kind known to a person skilled in the art under the name “MS Polymers”, or on polyurethanes with silane group termination, of the kind known to a person skilled in the art under the name “SPUR” (Silane Terminated Polyurethanes). The advantageous improvements in adhesion have been shown, however, in particular by polyurethane adhesives or polyurethane sealants, especially polyurethane adhesives which comprise polyurethane prepolymers containing isocyanate groups. Polyurethane adhesives of this kind are widely available commercially, especially under the name Sikaflex® from Sika Schweiz AG.

The adhesive typically has a thickness of more than 1 mm, preferably between 2 and 8 mm.

The substrate S1 and/or S2 may be of diverse kinds. Preferably at least one of the substrates, S1 or S2, is a mineral substrate or a metallic substrate. Particularly suitable metallic substrates are metals and alloys, especially steels, aluminum, and nonferrous metals, and also their alloys.

Suitable mineral substrates, in addition to concrete, mortar, and brick, include glass or glass ceramic in particular.

Other very suitable substrates are porous substrates, such as, for example, wood or polystyrene, especially in the form of insulating boards.

Where necessary, the substrates may be pretreated before the two-component or multicomponent aqueous primer composition, or the sealant or adhesive, is applied. Such pretreatments include, in particular, physical and/or chemical cleaning processes, such as abrading, sandblasting, brushing or the like, for example, or treatment with cleaners or solvents.

For instance, particularly in the case of painted substrates, especially automobile topcoats, it may be of advantage, atop the applied multicomponent aqueous primer composition, to use an additional primer which is optimized for adhesion to paint.

The two-component or multicomponent aqueous primer composition is especially suitable for the glazing of vehicles. In this application, in particular, the glass sheet, at least in the edge region, where typically a glass ceramic has been applied, is pretreated with a two-component or multicomponent aqueous primer composition, while the paint flange is typically pretreated with a paint primer. The sheet thus pretreated is bonded by means of one-component polyurethane adhesive to the painted sheet flange, which has been pretreated where appropriate, and so an impervious, force-fitting bond is produced.

The method described of adhesive bonding or of sealing produces an article.

Such articles are of a very wide variety of kinds. More particularly they are articles of industrial manufacture or of construction or civil engineering. An article of this kind may be a built structure, more particularly a built structure of construction or civil engineering, or may be a means of transport, such as a water or land or air vehicle, more particularly an automobile, a bus, a truck, a train or a boat, or a component for installation therein or thereon. Elastic bonds are particularly suitable in vehicle construction, such as the adhesional attachment of parts, such as plastic covers, trim strips, flanges, bumpers, driver's cabs or other components for installation on the painted bodywork of a means of transport, or the adhesional installation of glazing sheets into the bodywork. Examples of vehicles include automobiles, trucks, buses, rail vehicles, and boats.

With particular preference the articles are means of transport, more particularly an automobile, bus, truck, rail vehicle, boat or aircraft.

With the compositions of the invention it is possible to wait for a number of hours after the two components have been mixed before applying them, without any adverse effect on the adhesion of the adhesives applied thereto. The compositions of the invention therefore typically have pot lives of a number of hours, in particular more than 10 hours. Long pot lives are very advantageous for the applications.

It has emerged that with the compositions of the invention it is possible to achieve a sharp improvement in particular in the adhesion after storage under hot and humid conditions.

Additionally it has been found that, with the compositions of the invention, after the application of the composition to a variety of substrates, it is possible to wait for a very long time before applying the adhesive thereto, without any adverse effect on the adhesion of the adhesive applied thereto. The compositions of the invention therefore typically have open times of a number of months, in particular more than 120 days. Long open times are very advantageous for the applications.

It has emerged that with the compositions of the invention it is possible to achieve a sharp improvement in particular in the adhesion after storage under hot and humid conditions.

Additionally it has emerged that, when the two-component or multicomponent aqueous primer composition comprises carbon black, the pot life can be greatly extended without the flash-off time or the processing times being extended, and in particular without the adhesion being impaired.

### EXAMPLES

### Epoxy Resin Component K1

Ancarez™ AR550 Waterborne Epoxy Resin (“AR550”) from Air Products and also Waterpoxy® 1422 (“1422”) from Cognis were used.

Ancarez™ AR 550 is a solid-epoxy-resin dispersion of a solid bisphenol A diglycidyl ether resin (epoxide equivalent weight (EEW)=700-750 g/eq). This solid-epoxy-resin dispersion is milky white and has a solids content of 55% by weight, an epoxide equivalent weight (EEW) of 1300 g/eq, a viscosity (25° C.) (Brookfield) of 100 mPas, and a volume-average diameter (Dᵥ) of 0.5 μm.

Waterpoxy® 1422 is a solid-epoxy-resin dispersion of a solid bisphenol A diglycidyl ether resin (epoxide equivalent weight (EEW)=500-700 g/eq). This solid-epoxy-resin dispersion is milky white and has a solids content of 54% by weight, an epoxide equivalent weight (EEW) of 1200 g/eq, a viscosity (25° C.)(ASTM D 1824-65) of 2000-6000 mPas.

Further components were added where appropriate, in accordance with table 1, to these epoxy resin dispersions.

Polyamine component K2

### Aqueous Polyamine (WB)

Anquamine® 419, Air Products, polyamine/epoxy resin adduct (active H equivalent weight (ANEW) 284 g/eq, water content 150)(“419”)

Waterpoxy® 751, Cognis, polyamine/epoxy resin Adduct, content 58.50-61.5% by weight, amine number 174-192 mg KOH/g (“751”)

These aqueous polyamines were admixed where appropriate, in accordance with table 1, with further components.

TABLE 1
Compositions (numerical figures in parts by weight)

| | Ref. 1 | 1 | 2 | 3 | 4 | Ref. 2 | 5 | 6 |
|---|---|---|---|---|---|---|---|---|
| K1 | | | | | | | | |
| AR550 | 65.65 | 65.65 | 65.65 | 65.65 | 44.1 | | | |
| 1422 | | | | | | 67.37 | 66.53 | 44.91 |
| water | 20 | 20 | 20 | 20 | 5.3 | 20 | 20 | 6.24 |
| HS 2926¹ | | | | 1.0 | | | | |
| A187² | | | | | | | 1.0 | |
| K2 | | | | | | | | |
| 419 | 14.35 | 14.35 | 14.35 | 14.35 | 9.6 | | | |
| 751 | | | | | | 12.63 | 12.47 | 8.42 |
| water | | | | | 35.0 | | | 32.01 |
| carbon | | | | | 6 | | | 8.42 |
| black | | | | | | | | |
| A-1120² | | 1.0 | | | | | | |
| HS 2627⁴ | | | 1.0 | | | | | |

| | 7 | 8 | 9 | Ref. 3 | 10 | Ref. 4 | 11 |
|---|---|---|---|---|---|---|---|
| K1 | | | | | | | |
| AR550 | 44.1 | 44.1 | 44.1 | 44.1 | 44.1 | 65.6 | 65.9 |
| K2 | | | | | | | |
| 419 | 9.6 | 9.6 | 9.6 | 9.6 | 9.6 | 14.4 | 13.9 |
| water | 40.3 | 40.05 | 39.05 | 46.3 | 45.3 | 20 | 19.1 |
| carbon | 6.0 | 6.0 | 6.0 | | | | |
| black | | | | | | | |
| A-1120³ | | | 1.0 | | 1.0 | | 1.1 |
| Byk-012⁵ | | 0.25 | 0.25 | | | | |

¹HS 2926 = Dynasylan ® HYDROSIL 2926 (Degussa)
²A187 = 3-glycidyloxypropyltrimethoxysilane, Silquest ® A187 (GE Silicones, Switzerland)
³A1120 = N-(2-aminoethyl)-3-aminopropyltrimethoxy silane, Silquest ® A1120 (GE Silicones, Switzerland)
⁴HS 2627 = Dynasylan ® HYDROSIL 2627 (Degussa)
⁵Byk-012 = BYK ®-012 (BYK-Chemie, Germany)

The two components were mixed together and applied to the respective substrate by means of a felt soaked with the composition, and the applied composition was flashed off for 60 minutes, and a triangular bead of SikaTack® Ultrafast (“STUF”) Sikaflex®-250 DM-2 (“DM-2”) or Sikaflex®-250 HMV-2 (“HMV-2”) was applied by means of an extrusion cartridge and nozzle at 60° C. and 50% relative humidity. All of these are one-component, moisture-curing polyurethane adhesives which comprise polyurethane prepolymers containing isocyanate groups, and are available commercially from Sika Schweiz AG.

### Substrates:

Floatglass, Rocholl, Germany (“glass”)
ESG Ceramic, Ferro 14251, Rocholl, Germany (“ESG”)
Eloxed aluminum E6EV1, Rocholl, Germany (“Al-elox”)
Original glazing sheets with ceramic edge, adhesion was tested on ceramic:
Sheet 1: Mazda 323, Safevue (“sheet 1”)
Sheet 2: VW, Transport T4, Safevue (“Sheet 2”)
Sheet 3: Toyota Corolla, Pilkington (“Sheet 3”)

The eloxed aluminum was abraded using Scotch-Brite (3M) immediately prior to use.

Prior to the application of the compositions, all of the substrates were wiped down with a cellulose cloth soaked with isopropanol, and were flashed off for 10 minutes.

The adhesive was tested after a cure time of 7 days of climate chamber storage ('CS′) (23° C., 50% relative humidity), and also after subsequent water storage (“WS”) in water at 23° C. for 7 days, and also after subsequent storage under hot and humid conditions (“HS”) for 7 days at 70° C. and 1000 relative humidity.

The adhesion of the adhesive was tested by means of the “bead test”. In this test the bead is incised at the end just above the adhesion face. The incised end of the bead is held with round-end tweezers and pulled from the substrate. This is done by carefully rolling up the bead on the tip of the tweezers, and placing a cut vertical to the bead pulling direction down to the bare substrate. The rate of removal of the bead is selected so that a cut has to be made around every 3 seconds. The test length must amount to at least 8 cm. An assessment is made of the adhesive which remains on the substrate after the bead has been pulled off (cohesive fracture). The adhesive properties are evaluated by visual estimation of the cohesive fraction of the adhesion face:

“P” in the assessment denotes detachment of the primer from the substrate.
“PB” in the assessment denotes cohesive fracture within the primer.

The higher the fraction of cohesive fracture, the better the estimation of the adhesive bond. Test results with cohesive fractures of less than 5%, and especially less than 40%, are typically considered to be inadequate.

The adhesion results are reported in tables 2, 3, 4, 5, 6 and 7.

TABLE 2
Adhesion with Sikaflex ®-250 HMV-2 on original
glazing sheets.

| | Sheet 1 | | | Sheet 2 | | | Sheet 3 | | |
|---|---|---|---|---|---|---|---|---|---|
| HMV-2 | RT | WS | HS | RT | WS | HS | RT | WS | HS |
| Ref. 1 | 70 | 90 | 0P | 80P | 80P | 0P | 20 | 70 | 0P |
| 1 | 90P | 100 | 80 | 95 | 100 | 40 | 100 | 100 | 100 |
| 2 | 98 | 100 | 40P | 95P | 100 | 80 | 100 | 100 | 100 |
| 3 | 80P | 100 | 0P | 70 | 95 | 10P | 95 | 95 | 0P |
| 4 | 95 | 100 | 5P | 90P | 60P | 10P | 100 | 100 | 10P |

TABLE 3
Adhesion with SikaTack ® Ultrafast or
Sikaflex ®-250 DM-2 to various substrates.

| | Glass | | | ESG | | | Al-elox | | |
|---|---|---|---|---|---|---|---|---|---|
| | RT | WS | HS | RT | WS | HS | RT | WS | HS |
| STUF | | | | | | | | | |
| Ref. 2 | 70P | 0P | 0P | 100 | 5P | 0P | 90P | 40P | 50P |
| 5 | 100 | 95P | 10P | 100 | 100 | 20P | 95P | 100 | 40P |
| 6 | 100 | 0P | 75P | 100 | 75 | 95P | 100 | 30P | 75P |
| DM-2 | | | | | | | | | |
| Ref. 2 | 100 | 0P | 0P | 100 | 5P | 0P | 100 | 50 | 0P |
| 5 | 100 | 100 | 5P | 100 | 100 | 20P | 100 | 95 | 40P |
| 6 | 100 | 0P | 10P | 100 | 100 | 0P | 100 | 100 | 20P |

TABLE 4
Adhesion with Sikaflex ®-250 DM-2 and
Sikaflex ®-250 HMV-2 to different substrates.

| | Glass | | | ESG | | | Al-elox | | |
|---|---|---|---|---|---|---|---|---|---|
| | RT | WS | HS | RT | WS | HS | RT | WS | HS |
| DM-2 | | | | | | | | | |
| Ref. 3 | 90PB | 95PB | 5P | 80PB | 85PB | 100 | 95PB | 95PB | 20P |
| 7 | 95B | 100 | 100 | 80PB | 95PB | 100 | 100 | 95PB | 100 |
| 8 | 90PB | 100 | 100 | 80PB | 95PB | 100 | 95PB | 95PB | 100 |
| 9 | 95PB | 90PB | 100 | 80PB | 90PB | 100 | 90PB | 95PB | 100 |
| 10 | 95PB | 90PB | 100 | 90PB | 85PB | 100 | 95PB | 80PB | 75PB |
| HMV-2 | | | | | | | | | |
| Ref. 3 | 95 | 100 | 5P | 95PB | 95PB | 60P | 85PB | 100 | 0P |
| 7 | 100 | 100 | 100 | 100 | 100 | 100 | 100 | 100 | 98P |
| 8 | 95PB | 100 | 100 | 95PB | 100 | 100 | 95PB | 100 | 100 |
| 9 | 95PB | 95P | 100 | 80PB | 100 | 100 | 100 | 100 | 100 |
| 10 | 100 | 95PB | 90P | 100 | 95PB | 100 | 90PB | 95PB | 60P |

The results of tables 2, 3, and 4 show that the compositions of the invention greatly improve in particular the adhesion of the adhesives after storage under hot and humid conditions.

In tables 5 and 6 there were different waiting times after the two components had been mixed and before the composition was applied to glass. The time referred to by a person skilled in the art as the pot life is the time at which adhesion no longer occurs. The compositions utilized for table 5, accordingly, have a pot life of more than 10 hours.

TABLE 5
Adhesion after different waiting
times between mixing and application
to glass with different adhesives.

| | | DM-2 | | | HMV-2 | | |
|---|---|---|---|---|---|---|---|
| | | RT | WS | HS | RT | WS | HS |
| Ref. 4 | | | | | | | |
| 0 | min | 85 | 85 | 0P | 85 | 85 | 0P |
| 30 | min | 85 | 85 | 0P | 85 | 85 | 0P |
| 60 | min | 95 | 95 | 0P | 95 | 85 | 0P |
| 2 | h | 95 | 85 | 0P | 95 | 85 | 0P |
| 4 | h | 95 | 95 | 0P | 95 | 85 | 0P |
| 6 | h | 95 | 85 | 0P | 85 | 85 | 0P |
| 8 | h | 85 | 85 | 0P | 85 | 85 | 0P |
| 11 | | | | | | | |
| 0 | min | 85 | 85 | 95 | 85 | 85 | 95 |
| 30 | min | 95 | 85 | 95 | 85 | 85 | 95 |
| 60 | min | 95 | 85 | 95 | 95 | 85 | 95 |
| 2 | h | 95 | 85 | 95 | 95 | 85 | 95 |
| 4 | h | 95 | 85 | 95 | 95 | 85 | 95 |
| 6 | h | 95 | 85 | 95 | 85 | 85 | 95 |
| 8 | h | 85 | 85 | 95 | 95 | 85 | 95 |
| 10 | h | 85 | 85 | 95 | 85 | 85 | 95 |

It is evident from table 5 that the inventive examples exhibit a greatly improved adhesion in comparison to the comparative example, after storage under hot and humid conditions, even after very short waiting times.

For table 6 even longer waiting times were observed. From these results it is apparent firstly that the adhesion after storage under hot and humid conditions is greatly improved and secondly that the compositions of the invention exhibit a significantly longer pot life. This is the case especially for the compositions comprising carbon black.

In table 7, after the composition had been applied to glass, waiting took place for different times before the adhesive was applied. The time referred to by a person skilled in the art as the open time is the time at which adhesion no longer occurs. The compositions utilized for table 5, accordingly, have an open time of more than 120 days.

TABLE 6
Adhesion after different waiting
times between mixing and application
to glass with different adhesives.

| | | DM-2 | | | HMV-2 | | |
|---|---|---|---|---|---|---|---|
| | | RT | WS | HS | RT | WS | HS |
| Ref. 1 | | | | | | | |
| 4 | h | 40 | 50 | 10P | 100 | 100 | 0P |
| 8 | h | 100 | 100 | 0P | 100 | 100 | 0P |
| 24 | h | 100 | 100 | 0P | 100 | 100 | 0P |
| 32 | h | 40 | 50 | 0P | 100 | 100 | 0P |
| 2 | d | 100 | 95PB | 0P | 100 | 100 | 0P |
| 3 | d | gel.^{†} | gel.^{†} | gel.^{†} | gel.^{†} | gel.^{†} | gel.^{†} |
| 4 | d | gel.^{†} | gel.^{†} | gel.^{†} | gel.^{†} | gel.^{†} | gel.^{†} |
| 7 | d | gel.^{†} | gel.^{†} | gel.^{†} | gel.^{†} | gel.^{†} | gel.^{†} |
| 11 | | | | | | | |
| 4 | h | 95 | 85 | 95 | 95 | 85 | 95 |
| 8 | h | 85 | 85 | 95 | 95 | 85 | 95 |
| 24 | h | 95PB | 90PB | 20P | 95P | 70P | 75P |
| 32 | h | 95PB | 90PB | 20P | 90PB | 80PB | 50P |
| 2 | d | 90P | 50 | 10P | 90PB | 50 | 50P |
| 3 | d | 90 | 80P | 10P | 100 | 90P | 40P |
| 4 | d | 100 | 75P | 10P | 100 | 100 | 40P |
| 7 | d | gel.^{†} | gel.^{†} | gel.^{†} | gel.^{†} | gel.^{†} | gel.^{†} |
| 4 | | | | | | | |
| 4 | h | 40 | 50 | 40 | 100 | 100 | 100 |
| 8 | h | 100 | 100 | 100 | 100 | 100 | 100 |
| 24 | h | 100 | 95 | 100 | 100 | 100 | 100 |
| 32 | h | 100 | 100 | 100 | 100 | 100 | 100 |
| 2 | d | 100 | 100 | 100 | 95P | 100 | 100 |
| 3 | d | 100 | 100 | 100 | 100 | 100 | 100 |
| 4 | d | 95P | 100 | 100 | 95P | 100 | 100 |
| 7 | d | 100 | 100 | 100 | 100 | 100 | 100 |

^{†}gel. = gelled.

TABLE 7
Adhesion after different waiting
times between application of the
composition to glass and application
of the adhesive.

| | | DM-2 | | | HMV-2 | | |
|---|---|---|---|---|---|---|---|
| | | RT | WS | HS | RT | WS | HS |
| Ref. 4 | | 95 | 95 | 0P | 95 | 85 | 0P |
| 1 | h | 95 | 85 | 0P | 95 | 85 | 0P |
| 8 | h | 95 | 95 | 0P | 85 | 85 | 0P |
| 24 | h | 95 | 95 | 0P | 95 | 85 | 0P |
| 7 | d | 95 | 95 | 0P | 95 | 85 | 0P |
| 14 | d | 95 | 95 | 0P | 95 | 85 | 0P |
| 30 | d | 95 | 95 | 50P | 95 | 85 | 50P |
| 60 | d | 95 | 95 | 50P | 95 | 85P | 95 |
| 90 | d | 95 | 85P | 85P | 95 | 50P | 85P |
| 120 | d | 95 | 15P | 95 | 95 | 15P | 95 |
| 11 | | | | | | | |
| 1 | h | 95 | 95 | 95 | 95 | 95 | 95 |
| 8 | h | 95 | 95 | 95 | 85 | 95 | 85P |
| 24 | h | 95 | 95 | 95 | 95 | 95 | 85P |
| 7 | d | 95 | 95 | 95 | 95 | 85 | 95 |
| 14 | d | 95 | 95 | 95 | 95 | 95 | 95 |
| 30 | d | 95 | 85 | 95 | 95 | 85 | 95 |
| 60 | d | 95 | 95 | 95 | 85 | 95 | 95 |
| 90 | d | 95 | 95 | 95 | 95 | 95 | 95 |
| 120 | d | 95 | 95 | 50 | 95 | 95 | 85P |

It is evident from table 7 that the inventive examples exhibit a greatly improved adhesion in comparison to the comparative example, after storage under hot and humid conditions, even after very short waiting times.

1. A two-component or multicomponent aqueous primer composition composed of
a first component comprising
at least water
at least one epoxy resin
a second component comprising
at least one polyamine
and if desired at least one further component;
the two-component or multicomponent aqueous primer composition comprising carbon black and/or at least one epoxysilane and/or at least one epoxysiloxane and/or at least one aminosilane and/or at least one aminosiloxane and/or at least one mercaptosilane,
if epoxysilane and/or epoxysiloxane are present, they/it are/is not present in the same component as the aminosilane and/or aminosiloxane.

2. The two-component or multicomponent aqueous primer composition of claim 1, wherein the second component comprises water.

3. The two-component or multicomponent aqueous primer composition of claim 1, wherein the primer composition has two components and in that carbon black is part of the second component.

4. The two-component or multicomponent aqueous primer composition of claim 1, wherein the primer composition has two components and in that the epoxysilane and/or epoxysiloxane are/is part of the first component.

5. The two-component or multicomponent aqueous primer composition of claim 1, wherein the primer composition has two components and in that the aminosilane and/or aminosiloxane and/or mercaptosilane are/is part of the second component.

6. The two-component or multicomponent aqueous primer composition of claim 1, wherein the primer composition has three components and wherein the third component comprises carbon black and/or epoxysilane and/or epoxysiloxane and/or aminosilane and/or aminosiloxane and/or mercaptosilane.

7. The two-component or multicomponent aqueous primer composition, wherein the epoxy resin is a solid epoxy resin.

8. The two-component or multicomponent aqueous primer composition of claim 7, wherein the solid epoxy resin is a solid bisphenol A diglycidyl ether resin.

9. The two-component or multicomponent aqueous primer composition of claim 7, wherein the solid epoxy resin has a volume-average diameter of less than 1 μm.

10. The two-component or multicomponent aqueous primer composition of claim 1, wherein the polyamine is a reaction product.

11. The two-component or multicomponent aqueous primer composition of claim 1, wherein the polyamine is a reaction product of a diglycidyl ether of bisphenol A and/or bisphenol F with a polyoxyalkylenediamine or polyoxyalkylenetriamine.

12. The two-component or multicomponent aqueous primer composition of claim 1, wherein the epoxysilane has the formula (I) 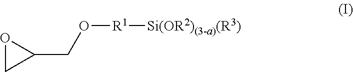
where R¹ is a linear or branched alkylene group having 1 to 6 C atoms;
R² is H or an alkyl group having 1 to 4 C atoms, or an acyl group;
R³ is H or an alkyl group having 1 to 10 C atoms;
and a is 0, 1 or 2.

13. The two-component or multicomponent aqueous primer composition of claim 1, wherein the aminosilane has the formula (II), (III) or (IV) 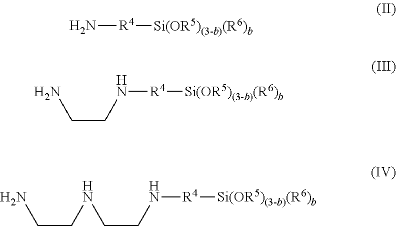
where R⁴ is a linear or branched alkylene group having 1 to 6 C atoms;
R⁵ is H or an alkyl group having 1 to 4 C atoms, or an acyl group;
R⁶ is H or an alkyl group having 1 to 10 C atoms;
and b is 0, 1 or 2.

14. The two-component or multicomponent aqueous primer composition of claim 12, wherein the aminosilane is N-(2-aminoethyl)-3-aminopropyltrimethoxysilane.

15. The two-component or multicomponent aqueous primer composition of claim 1, wherein the first component and/or second component further comprise/s at least one emulsifier and/or surfactant.

16. The two-component or multicomponent aqueous primer composition of claim 1, wherein the second component further to the polyamine comprises
at least one emulsifier having a polyoxyalkylenediamine structure and a
at least one coemulsifier having a poly(alkylene)polyamine structure.

17. The two-component or multicomponent aqueous primer composition of claim 1, wherein the epoxy resin is present as a dispersion in water in the first component and the polyamine is present as an emulsion or dispersion in water in the second component.

18. The two-component or multicomponent aqueous primer composition of claim 1, wherein the aminosiloxane comes about from the condensation of an aminosilane with a further silane, with formation of at least one siloxane bond.

19. The two-component or multicomponent aqueous primer composition of claim 1, wherein
the fraction of the carbon black is 0% to 20%,
the fraction of the epoxysilane is 0% to 5%,
the fraction of the epoxysiloxane is 0% to 5%,
the fraction of the aminosilane is 0% to 5%,
the fraction of the aminosiloxane is 0% to 5%, and
the fraction of the mercaptosilane 0% to 5%
based in each case on the weight of the two-component or multicomponent aqueous primer composition.

20. (canceled)

21. A method of adhesive bonding or of sealing, comprising the steps of
i) mixing the two or more components of a two-component or multicomponent aqueous primer composition of claim 1;
ii) applying the mixed primer composition to a substrate to be bonded or sealed;
iii) flashing off the primer composition;
iv) applying an adhesive or sealant to the flashed-off composition which is on the substrate;
v) contacting the adhesive or sealant with a second substrate;
or
i′) mixing the two or more components of a two-component or multicomponent aqueous primer composition of claim 1;
ii′) applying the mixed primer composition to a substrate to be bonded or sealed;
iii′) applying an adhesive or sealant to the surface of a second substrate;
iv′) contacting the adhesive or sealant with the flashed-off composition which is on the substrate;
or
i″) mixing the two or more components of a two-component or multicomponent aqueous primer composition of claim 1;
ii″) applying the mixed primer composition to a substrate to be bonded or sealed;
iii″) flashing off the primer composition;
iv″) applying an adhesive or sealant between the surfaces of the substrates;
the second substrate being composed of the same or different material as the substrate.

22. The method of claim 21, wherein step v), iv′) or iv″) is followed by a step vi) of curing the adhesive or sealant.

23. The method of claim 21, wherein the adhesive or sealant is a polyurethane adhesive, which comprises polyurethane prepolymers containing isocyanate groups.

24. The method of claim 21, wherein the thickness of the adhesive is more than 1 mm.

25. The method of claim 21, wherein at least one of the substrates, is a mineral substrate or a metallic substrate.

26. An article in which the production method of claim 21 is carried out.

27. The article of claim 26, wherein the article is a means of transport.

28. A method of forming polyurethane adhesives and/or polyurethane sealants comprising:
providing the two-component or multicomponent aqueous primer composition of claim 1 as a primer.
